(19) United States
(12) Patent Application Publication
(10) Pub. No.: US 2023/0396700 A1
(43) Pub. Date: Dec. 7, 2023

(54) Multi-Cut Display-Panel Design Enabling System Integration into Two or More End Products

(71) Applicant: Google LLC, Mountain View, CA (US)

(72) Inventors: Adrian Gheorghe Manea, Libertyville, IL (US); Michael J. Lombardi, South Barrington, IL (US); Yi Tao, San Jose, CA (US); Jerry Younghun Kim, Buffalo Grove, IL (US); Esther Yekyung Shin, Chicago, IL (US)

(73) Assignee: Google LLC, Mountain View, CA (US)

(21) Appl. No.: 18/450,948

(22) Filed: Aug. 16, 2023

Related U.S. Application Data
(60) Provisional application No. 63/519,671, filed on Aug. 15, 2023.

(51) Int. Cl. H04M 1/02

(52) U.S. Cl. CPC H04M 1/0266; H04M 1/0277

(57) ABSTRACT

This document describes systems and techniques directed at a multi-cut display-panel design enabling system integration into two or more end products. In aspects, a display panel includes a display panel body, having a pixel array and related electronics, as well as one or more border extensions disposed at least partially around a display border of the display panel body. The display panel further includes one or more cutting profiles to separate one or more borders extensions (or no border extensions) for integration in differently sized mounting structures of various electrical devices. Through these systems and techniques, a single display panel with a multi-cut design can be manufactured for integration within dissimilarly shaped electronic devices, saving costs associated with conventional manufacturing techniques, improving electronic device reliability, and antenna performance.

### CROSS-REFERENCE TO RELATED APPLICATIONS

This application claims priority to U.S. Provisional Application Ser. No. 63/519,671, filed Aug. 15, 2023, the disclosure of which is incorporated by reference its entirety.

### SUMMARY

This document describes systems and techniques directed at a multi-cut display-panel design enabling system integration into two or more end products. In aspects, a display panel includes a display panel body, having a pixel array and related electronics, as well as one or more border extensions disposed at least partially around a display border of the display panel body. The display panel further includes one or more cutting profiles to separate one or more borders extensions (or no border extensions) for integration in differently sized mounting structures of various electrical devices. Through these systems and techniques, a single display panel with a multi-cut design can be manufactured for integration within dissimilarly shaped electronic devices, saving costs associated with conventional manufacturing techniques, improving electronic device reliability, and antenna performance.

In one example, a display panel body includes a display border, the display border surrounding a plurality of electrical components that are integrated within the display panel body. A border extension surrounds at least portions of the display border. The border extension is contiguous with the at least portions of the display border and extends from the display border to an outer perimeter. The border extension is configured to receive an adhesive structure to secure the display panel to a mounting structure of an electrical device.

This Summary is provided to introduce systems and techniques directed at a multi-cut display-panel design enabling system integration into two or more end products as further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques directed at a multi-cut display-panel design enabling system integration into two or more end products are described in this document with reference to the following drawings. The same numbers are used throughout the drawings to reference like features and components:

FIG. 1 is a schematic diagram of a configurable display panel including a display panel body and a plurality of border extensions;

FIG. 2 is a schematic view of a layer on which multiple iterations of the configurable display panel of FIG. 1 are formed;

FIGS. 3A-3C are cross-sectional views of edges of display panels formed with one or more border extensions;

FIGS. 4A-4C are cross-sectional views of edges of electrical devices including different forms of the display panels of FIGS. 3A-3C; and

FIG. 5 is a flow diagram of an example method of forming a configurable display panel and installing a selected form of the display panel in an electrical device.

### DETAILED DESCRIPTION

### Overview

Development of display panels for electrical devices, such as mobile telephones and laptop computers, is a costly endeavor. In a first respect, electronics within the display panel, including light-emitting pixel circuits, routing circuitry, etc., have to be precisely designed to fit the electrical device. In another respect, the manufacturing process to make the display panels, including processes for a deposition of thin-film materials, photolithography, and so on may involve hundreds of detailed steps. Then, as new or distinct electrical devices are developed, altogether different display panels are designed, and the manufacturing process begins anew. The cost associated with developing multiple display panel designs in addition to the manufacturing fees may result in substantial cost savings.

Many electrical devices are similarly sized and shaped, and therefore include similarly sized and shaped display panels, though they may not be identical. If a single display panel could be developed and manufactured for use in multiple differently sized and shaped electrical devices, it would result in substantial cost savings for the electrical device vendor.

Further, as recent trends in electrical device development aim to minimize display borders (e.g., bezels), it has been found that such display border reductions negatively affect device reliability and antenna performance. Thus, there may be some benefits to extending and/or maintaining display border sizes. For example, when edges of the display panel are secured to a mounting structure of the electrical device, extending edges of a display panel from the display panel body may reduce strain in the display panel by displacing the display panel body from an adhesive or other mechanical mechanism that secures the display panel to the mounting structure. Similarly, when an antenna system is disposed behind the display panel body, extending the edges of the display panel where the display panel is secured to the mounting structure distances the antenna system from the mounting structure. Distancing the antenna system from the mounting structure may improve antenna performance.

This document describes systems and techniques directed at a multi-cut display-panel design enabling system integration into two or more end products. In aspects, a display panel includes a display panel body, having a pixel array and related electronics, as well as one or more border extensions disposed at least partially around a display border of the display panel body. The display panel further includes one or more cutting profiles to separate one or more borders extensions (or no border extensions) for integration in differently sized mounting structures of various electrical devices. Through these systems and techniques, a single display panel with a multi-cut design can be manufactured for integration within dissimilarly shaped electronic devices, saving costs associated with conventional manufacturing techniques, improving electronic device reliability, and antenna performance.

### EXAMPLE SYSTEMS

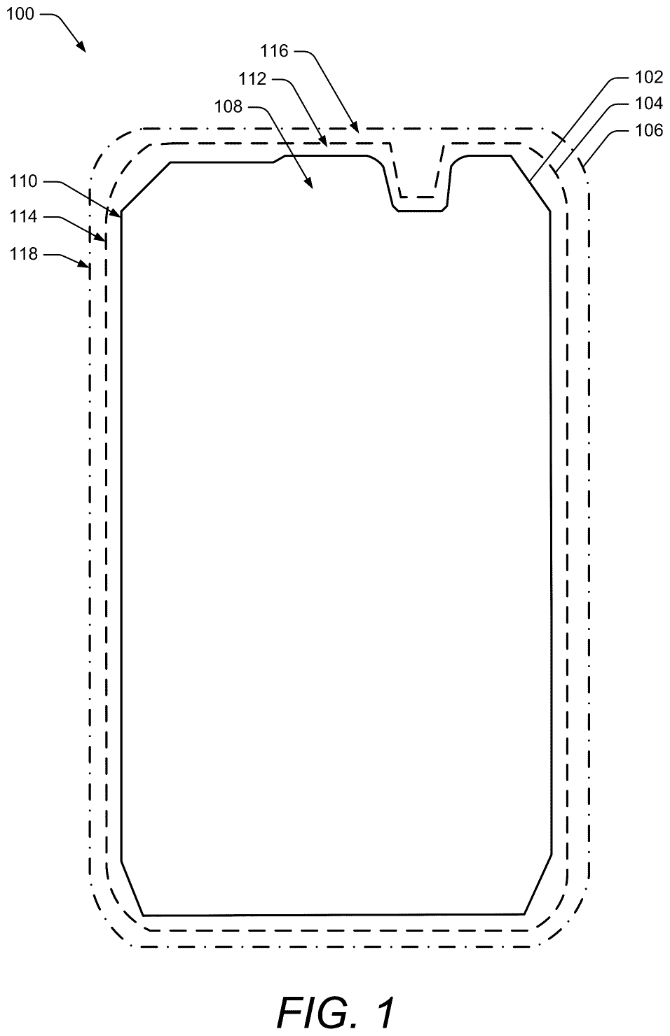

FIG. 1 illustrates an example configurable display panel 100 that may be used in electrical devices (not shown in FIG. 1) that are shaped and/or sized to employ different display panels. As described herein, a configurable display panel may refer to a display panel that is designed to be cut along one or more cut lines to form a resulting display panel with a different size and/or shape. The configurable display panel 100 includes a first display panel 102 (outlined by a solid line), a second display panel 104 (outlined by a dashed line), and a third display panel 106 (outlined by a dotted and dashed line). The first display panel 102 includes a display panel body 108 that includes within a display border 110 some or all of the electronics used in the first display panel 102, the second display panel 104, and the third display panel 106, as further described below.

The second display panel 104 includes the display panel body 108 surrounded (at least partially) by a first extension border 112. The first extension border 112 extends from the display border 110 of the display panel body 108 to a first outer perimeter 114. The first extension border 112 shares a planar surface with the display panel body 108, as further described below. As also described further below, the first extension border 112 provides a region at which the second display panel 104 is attachable to a mounting structure of an electrical device (not shown in FIG. 1) without having to directly attach the display panel body 108 to the mounting structure. For example, the first border extension 112 may be configured to receive an adhesive structure to secure the second display panel 104 to the mounting structure of the electrical device. The first border extension 112 includes no electronics or metallic components.

The third display panel 106 includes the second display panel 104 (which includes the display panel body 108 and the first extension border 112) surrounded (at least partially) by a second extension border 116. The second extension border 116 extends from the first outer perimeter 114 of the first extension border 112 to a second outer perimeter 118 of the second extension border 116. The second extension border 116 also shares a planar surface with the first extension border 112 and the display panel body 108, as further described below. Like the first extension border 112, the second extension border 116 provides a region at which the third display panel 106 is attachable to a mounting structure of an electrical device (not shown in FIG. 1) without having to directly attach the display panel body 108 to the mounting structure. For example, the second border extension 116 may be configured to receive an adhesive structure to secure the third display panel 106 to the mounting structure of the electrical device. Like the first border extension 112, the second border extension 116 includes no electronics or metallic components.

As can be seen in FIG. 1, the three display panels 102, 104, and 106 included in the configurable display panel 100 may fit different electrical devices having mounting structures of different sizes. Although the three display panels 102, 104, and 106 are illustrated as being substantially rectangular, it will be appreciated by those skilled in the art that the three display panels 102, 104, and 106 could form any of a variety of two- or three-dimensional shapes. The display panel body 108 may include all of the electronic components of the configurable display panel 100, whereas, in some implementations, the first border extension 112 and the second border extension 116 include no electronic components. In this way, the configurable display panel 100 provides all the functions of the display panel body 108 whether or not the first border extension 112 and/or the second border extension 116 are left in place. Thus, the first border extension 112 and the second border extension 116 may be removed from the display panel body 108 to present the first display panel 102 that can be used in an electrical device with a mounting structure sized to receive the first display panel 102.

Similarly, the second border extension 116 may be removed from the configurable display panel 100 to form the second display panel 104 that can be used in an electrical device with a mounting structure sized to receive the second display panel 104. Finally, without removing either the first border extension 112 or the second border extension 116 from the configurable display panel 100, the third display panel 106 is formed that can be used in an electrical device with a mounting structure sized to receive the second display panel 106. Thus, with the design of the single display panel body 108—and the deposition, photolithography, and other processes developed to form the display panel body 108, three different sizes of display panel may be created by selectively removing or leaving in place the first border extension 112 and/or the second border extension 116.

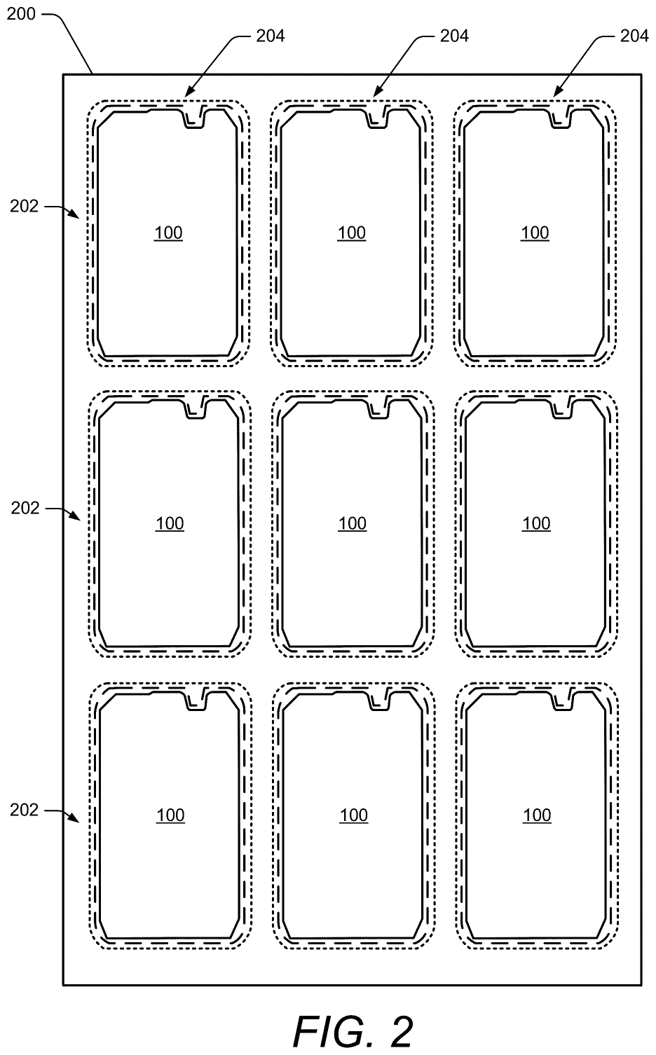

FIG. 2 shows a layer 200 which provides the substrate for multiple configurable displays 100. The layer 200 may be comprised of a film, plastic, ceramic, and/or a glass, or another material that may provide a suitable outward-facing layer for a display. Many configurable displays 100 may be formed on the layer 200 in rows 202 and columns 204. In a single processing run, multiple configurable displays 100 may be formed that that can be configured by selectively removing or leaving in place the first border extension 112 and/or the second border extension 116, as described with reference to FIG. 1. Thus, each of one or more of the first display screen 102, the second display screen 104, and the third display screen 106—suitable for use in different electrical devices—may be formed in a single processing run.

As further described below, for one of the displays 100 formed on the layer 200, both the first border extension 112 and the second border extension 116 may be removed and the display panel body 108 then adhesively attached within a mounting structure of an electrical device. For another of the displays 100 formed on the layer 200, the second border extension 116 may be removed and the resulting display panel adhesively attached to a second mounting structure of a second electrical device at the first border extension 112. For still another of the displays 100 formed on the layer 200, both the first border extension 112 and the second border extension 116 may be left in place around the display panel body 108 and the resulting display panel adhesively attached to a third mounting structure of a third electrical device. The electrical devices all may have mounting structures of different sizes, yet all three of the electrical devices may include a display formed from one of the display panels 100 formed on the layer 200 in a single production run.

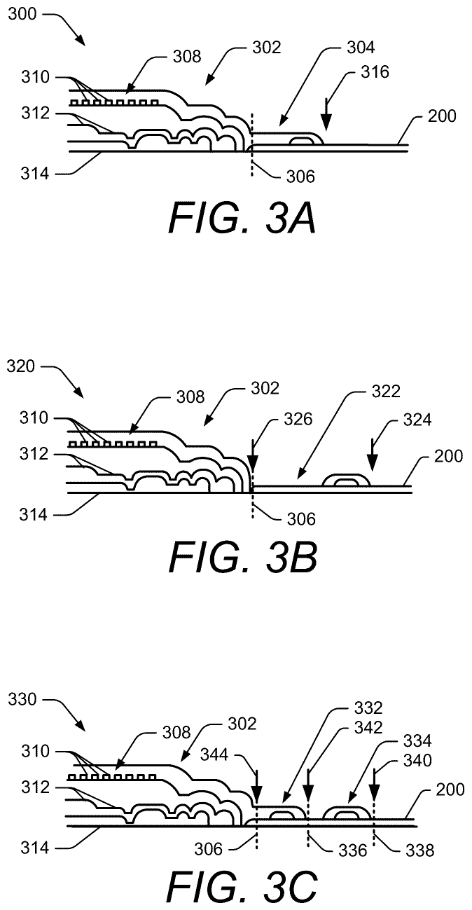

FIGS. 3A-3D show a cross-sectional views of different implementations of configurable displays to include one or more border extensions. More particularly, the examples of FIGS. 3A-3C show edges of display panels as may be formed on the layer 200 from which the display panels may be cut or otherwise separated.

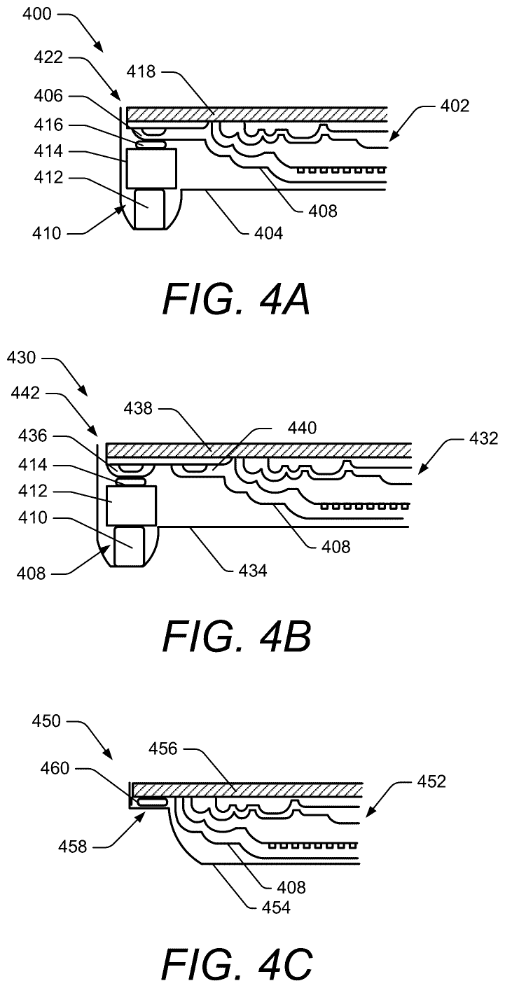

FIG. 3A shows a display panel 300 that includes a display panel body 302 and a border extension 304. As previously described with reference to the display panel body 108 of FIG. 1, within a display border 306, the display panel body 302 includes a pixel array 308 of pixel circuits 310 configured to illuminate upon electrical activation. The display panel body 302 also includes other circuitry 312 that supports generation of images, touch response or other functions provided at a surface 314 of the display panel 300. The display panel 300 may be separated from the layer 200 at a cut line 316 using a laser or another cutting device (not shown). The cut line 316 is at or outside of the border extension 304. The border extension 304 is configured to receive an adhesive structure to secure the display panel 300 to a mounting structure of an electrical device, as described below with reference to FIG. 4A.

FIG. 3B shows a display panel 320 that includes the display panel body 302 and a border extension 322 that is comparatively larger than the border extension 304 of the display panel 300 of FIG. 3A. As previously described with reference to FIG. 1, the border extension 322 may be sized to enable the use of the display panel body 302 with electrical devices configured to receive display panels of different sizes. The display panel 320 may be separated from the layer 200 at a cut line 324 at or outside the border extension 322 using a laser or another cutting device (not shown). The border extension 322 is configured to receive an adhesive structure to secure the display panel 320 to a mounting structure of an electrical device, as described below with reference to FIG. 4A. Thus, using the same display panel body 302, the display panel 300 and the border extension 304 of FIG. 3A may fit a relatively smaller mounting structure of one electrical device while the display panel 320 and the border extension 322 of FIG. 3B may fit a relatively larger mounting structure of another electrical device—with both using the same display panel body 302.

In addition, instead of separating the display panel 320 from the layer 200 at the cut line 324, the display panel 320 may be cut at an inner cut line 326, thereby separating the border extension 322 from the display panel body 302. Thus, in addition to the relatively larger border extension 322 allowing the display panel 320 to fit a relatively larger mounting structure of an electrical device, the border extension 322 may be separated with the display panel body 302 alone being received within a relatively smaller mounting structure.

FIG. 3C shows a display 330 incorporating the display panel body 302 and multiple border extensions 332 and 334. A first border extension 332 extends from the display border 306 to a first outer perimeter 336 of the first border extension 332. A second border extension extends from the first outer perimeter 336 of the first border extension 332 to a second outer perimeter 338 of the second border extension 334. The display panel 330 may be cut to different sizes using a laser or another cutting device depending on the intended use of the display panel. To form the display panel 330 in its largest size, the display panel 330 is cut from the layer 200 at an outer cut line 340 at the second outer perimeter 338 of the second border extension 334. The second border extension 334 is configured to receive an adhesive structure to secure the display panel 330 to a mounting structure of an electrical device. To form the display panel 330 in a relatively smaller size, the display panel 330 is cut from the layer 200 at a second cut line 342 at the first outer perimeter 336 of the first border extension 332, thereby removing the second border extension 334 from the display panel 330. The first border extension 332 is configured to receive an adhesive structure to secure the display panel 330 to a mounting structure of an electrical device. To form the display panel 330 in its smallest size, the display panel 330 is cut from the layer 200 at a third cut line 344 at the display border 306 of the display panel body 302. The display panel body 302 is then secured to a mounting structure of an electrical device. Thus, from one design and one manufacturing process, display panels of three different potential sizes may be formed, allowing investment in design and manufacturing systems of the display panel body 302 to be spread across the development and production of multiple different electrical devices.

Referring to FIGS. 4A-4C, display panels of different sizes are secured to the mounting structures of different electrical devices. FIG. 4A shows an electrical device 400 in which a display panel 402 is secured to a mounting structure 404 of the electrical device 400. The display panel 402 includes a border extension 406 extending from the display panel body 408, as previously described with reference to FIGS. 3A and 3B. The display panel 402 is secured to the mounting structure 404 by securing the border extension 406 to the mounting structure 404 with an adhesive structure 410. The adhesive structure 410, for example, may include a pressure sensitive adhesive 412 that attaches the mounting structure 404 to a plastic trim section 414. The plastic trim section 414, in turn, is secured to the border extension 406 with a glue 416. A cover glass 418 (if a cover glass is desired to cover the layer on which the display panel 402 is formed) is adhesively attached to the display panel 402, completing the assembly. As previously stated, attaching the display panel 402 to the mounting structure 404 at the border extension 406 relieves strain from a surface of the display panel body 408. Removing the display panel body 408 from an edge 422 of the mounting structure 404, which may be formed of metal, also may improve performance of an antenna (not shown in FIG. 4A) disposed under the display panel 402. Distancing the antenna from the edge 422 of the mounting structure 404 may prevent the mounting structure 404 from interfering with operation of the antenna.

FIG. 4B shows an electrical device 430 in which a display panel 432 is secured to a mounting structure 434 of the electrical device 430. The display panel 432 includes two border extensions, an outer border extension 436 and an inner border extension 440, extending from the display panel body 408, as previously described with reference to FIG. 3C. As previously described, the display panel body 408 is the same in the display panel 402 of FIG. 4A and the display panel 432 of FIG. 4B, allowing the same display panel body 408 design to be used in the differently-sized display panels 402 and 432 by virtue of the border extensions extending from the display panel body 408. The display panel 432 is secured to the mounting structure 434 by securing the outer border extension 436 to the mounting structure 434 with the adhesive structure 410, including the pressure sensitive adhesive 412, the plastic trim section 414, and the glue 416 that is secured to the outer border extension 436. A cover glass 438 (if a cover glass is desired to cover the layer on which the display panel 402 is formed) is adhesively attached to the display panel 432, completing the assembly. An inner border extension 440 is not used to attach the display panel 432 to the mounting structure 434, but extends the size of the display panel 432 as previously described. As previously described, attaching the display panel 432 to the mounting structure 434 at the border extension 436 relieves strain from a surface of the display panel body 408 and may improve both electronic device reliability and antenna performance by distancing the antenna beneath the display panel body 408 from an edge 442 of the mounting structure 434.

FIG. 4C shows an electrical device 450 in which a display panel 452 is secured to a mounting structure 454 of the electrical device 450. The display panel 452 does not include a border extension, as in the examples of FIGS. 4A and 4B. Instead, the display panel 452 includes only the display panel body 408, allowing the same display panel body 408 design to be used in another differently-sized electrical device 450. The display panel 452 is secured to the mounting structure 454 by securing the cover glass 456 to the mounting structure 454 with an adhesive structure 458. The adhesive structure 458 may include only a pressure sensitive adhesive 460 to attach the cover glass 456 to the mounting structure 454. The cover glass 456, being adhesively-attached to the display panel 452, secures the display panel 452 to the mounting structure 454 of the electrical device 450.

In sum, the incorporation of one or more border extensions, which may be selectively included in or separated from a display panel, enables a same display panel body design and its included electronics to be used to form display panels of different sizes for use in different electrical devices.

### EXAMPLE METHOD

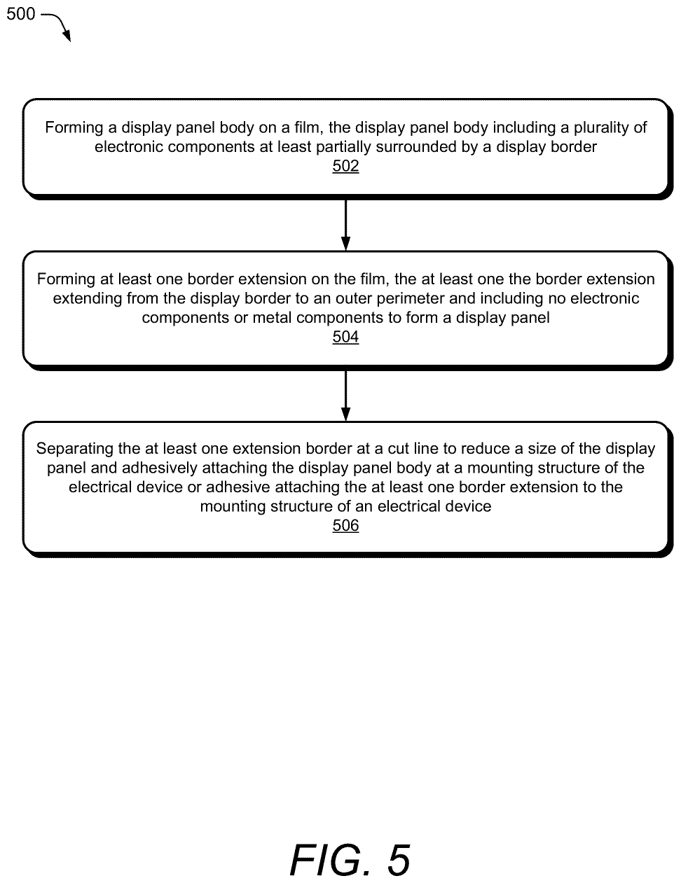

FIG. 5 is a flow diagram of an example method 500 of forming a display panel and installing the display panel in an electrical device. At a block 502, a display panel body is formed on a layer, the display panel body including a plurality of electronic components at least partially surrounded by a display border. At a block 504, at least one border extension is formed on the layer, the at least one the border extension extending from the display border to an outer perimeter and including no electronic components or metal components to form a display panel. At a block 506, either separating the at least one extension border at a cut line to reduce a size of the display panel and adhesively attaching the display panel body to the mounting structure of an electrical device or adhesively attaching the at least one border extension to the mounting structure.

As previously described with reference to FIG. 2, a similar method to the example method 500 may be employed to form a second display panel of a different size from the same layer to fit a second mounting structure of a second electrical device. Independently of whether the display panel was separated the at least one extension border at the cut line to reduce the size of the display panel or the at least one border extension was adhesively attached to the mounting structure, the second display panel may be separated from one or more second border extensions or be adhesively attached to the second electrical device at the one or more second border extensions.

The preceding discussion describes systems and techniques directed at a multi-cut display-panel design enabling system integration into two or more end products. These systems and techniques may be realized using one or more of the entities or components shown in FIGS. 1-4C and used as described with reference to FIG. 5. However, the figures illustrate only some of the many possible systems capable of employing the described techniques.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### CONCLUSION

Although implementations of systems and techniques directed at a multi-cut display-panel design enabling system integration into two or more end products have been described in language specific to certain features and/or methods, the subject of the appended claims is not necessarily limited to the specific features or methods described. Rather, the specific features and methods are disclosed as example implementations for a multi-cut display-panel design enabling system integration into two or more end products.

What is claimed is:

1. A display panel comprising:
a display panel body, the display panel body having a display border that surrounds a plurality of electrical components that are integrated within the display panel body; and
a first border extension surrounding at least portions of the display border, the first border extension contiguous with the at least portions of the display border and extending from an inner perimeter to an outer perimeter, the inner perimeter adjacent to the display border, the first border extension configured to receive an adhesive structure to secure the display panel to a first mounting structure of a first electrical device.

2. The display panel of claim 1, further comprising:
a cut region disposed between the display border and the inner perimeter of the first border extension, the cut region configured to be separated by a cutting device to selectively separate the first border extension from the display panel body, and wherein the display panel is configured to be secured within a second mounting structure of a second electrical device.

3. The display panel of claim 2, wherein the display panel is configured to be secured within the second mounting structure of the second electrical device by situating the display panel between the second mounting structure of the second electrical device and a cover glass and securing the cover glass to the second mounting structure of the second electrical device.

4. The display panel of claim 2, wherein the second electrical device is smaller than the first electrical device.

5. The display panel of claim 1, wherein the first border extension includes no metallic elements.

6. The display panel of claim 1, further comprising:
a second border extension surrounding at least portions of the first border extension, the second border extension contiguous with the at least portions of the first border extension and extending from the display border to a second outer perimeter, the second border extension configured to receive the adhesive structure to secure the display panel to a third mounting structure of a third electrical device.

7. The display panel of claim 6, further comprising:
a second cut region disposed between the outer perimeter of the display border and a second inner perimeter of the second border extension, the second cut region configured to be separated by a cutting device to selectively separate the second border extension from the first border extension.

8. The display panel of claim 6, wherein the second border extension includes no metallic elements.

9. The display panel of claim 1, wherein the plurality of electrical components comprise:
a pixel array of pixel circuits, the pixel array configured to illuminate upon electrical activation, and wherein the display border defines a boundary of an active area of the display panel.

10. The display panel of claim 1, further comprising:
a cut region disposed between the display border and the inner perimeter of the border extension; and
a second border extension surrounding at least portions of the first border extension, the second border extension contiguous with the at least portions of the first border extension and extending from the display border to a second outer perimeter, the second border extension configured to receive the adhesive structure to secure the display panel to a third mounting structure of a third electrical device.

11. The display panel of claim 10, further comprising:
a second cut region disposed between the outer perimeter of the display border and a second inner perimeter of the second border extension, the second cut region configured to be separated by a cutting device to selectively separate the second border extension from the first border extension.

12. A method comprising:
forming a display panel body on a layer, the display panel body including a plurality of electrical components surrounded by a display border;
forming at least one border extension on the layer, the at least one the border extension extending from the display border to an outer perimeter and including no electronic components or metal components to form a display panel; and
either:
separating the at least one extension border at a cut line to reduce a size of the display panel and adhesively attaching the display panel body to a mounting structure of an electrical device; or
adhesively attaching the at least one border extension to the mounting structure of the electrical device.

13. The method of claim 12, further comprising:
forming a second display panel body on the layer, the second display panel body including a second plurality of electrical components surrounded by a second display border;
forming at least one second border extension around the second display panel body on the layer, the at least second additional border extension extending from the second display border to a second outer perimeter and including no electronic components or metal components to form a second display panel; and
independently of whether the at least one extension border is separated at the cut line to reduce the size of the display panel or the at least one border extension was adhesively attached to the mounting structure of the electrical device, either:
separating the at least one second extension border at a second cut line to reduce a size of the second display panel and adhesively attaching the second display panel body to a second mounting structure of a second electrical device; or
adhesively attaching the at least one second border extension to the second mounting structure of the second electrical device.
